(19) United States
(12) Patent Application Publication
(10) Pub. No.: US 2008/0297331 A1
(43) Pub. Date: Dec. 4, 2008

(54) ANTITHEFT CODING DEVICE

(75) Inventor: Toshiki KUROKAWA, Hyogo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 11/947,356

(22) Filed: Nov. 29, 2007

(30) Foreign Application Priority Data
May 28, 2007 (JP) 2007-140362

(51) Int. Cl. B60R 25/00

(52) U.S. Cl. 340/426.35

(57) ABSTRACT

First given data is transmitted to a key (1) from a control unit (2) on a vehicle side, and the key (1) that is equipped with a transponder (10) generates, based on the transmitted first given data, second given data having a different number of bytes through a given arithmetic operation (first arithmetic operation) to transmit the second given data to the control unit (2). The control unit (2) conducts the same given arithmetic operation (first arithmetic operation) therein, and checks whether the obtained arithmetic result coincides with the second given data that has been received from the key (1) or not to permit the start of an engine. Also, the control unit (2) stores the received second given data in advance, and conducts a given arithmetic operation (second given arithmetic operation) to obtain the arithmetic result for use as the next first given data.

### BACKGROUND OF THE INVENTION

1. Field of the Invention

The present invention relates to an antitheft coding device, and more particularly to an antitheft coding device for preventing a theft of an automobile or the like using a keyless entry system.

2. Description of the Related Art

Currently, in an antitheft control device for an automobile or the like, such a system is generally employed that a key unit in a key which is carried by a user transmits and receives data with respect to a control unit in a vehicle to check data. This type of device employs a coding system using random numbers as transmitted data and received data (for example, refer to JP 7-274258 A).

In the above conventional system, random numbers are generally used in order to convert the transmitted data and the received data into coded data. When the random numbers are saved in the memory in use, a large-capacity memory is required. This accompanies such problems that the device cannot be downsized, and the costs increase.

Also, when random numbers based on a known calculation system (linear congruential method or a primitive polynomial of M series) are used as they are, there arises such a problem that the security is reduced.

### SUMMARY OF THE INVENTION

The present invention has been made to solve the above problems, and therefore an object of the present invention is to provide an antitheft coding device that ensures high security with the use of a small-capacity memory.

The present invention provides an antitheft coding device including:

a key on a user side; and

a control unit equipped on a vehicle side,

in which the key includes:
a data receiving section that receives first given data that is transmitted from the control unit;
an arithmetic section that conducts a first given arithmetic operation on the received first given data to generate second given data; and
a data transmitting section that transmits the generated second given data to the control unit,

in which the control unit includes:
a transmitting section that transmits the first given data to the key;
a first arithmetic section that conducts the same arithmetic operation as the first given arithmetic operation on the same data as the transmitted first given data to generate third given data;
a receiving section that receives the second given data from the key;
a checking section that checks the third given data generated by the first arithmetic section against the second given data that has been received by the receiving section, and permits a start of an engine equipped in a vehicle when the third given data and the second given data coincide with each other;
a memory section that stores the second given data that has been received by the receiving section; and
a second arithmetic section that conducts a second given arithmetic operation on the second given data that has been stored in the memory section to generate first given data to be transmitted to the key for subsequent checking, and

in which the second given data has the same number of bytes as the number of bytes of the third given data, which is different from the number of bytes of the first given data.

With the above configuration, the high security can be ensured with the small-capacity memory.

### BRIEF DESCRIPTION OF THE DRAWINGS

In the accompanying drawings:

FIG. 1 is a block diagram showing a configuration of an antitheft coding device according to a first embodiment of the present invention; and

FIG. 2 is a block diagram showing a configuration of an antitheft coding device according to a second embodiment of the present invention.

### DETAILED DESCRIPTION OF THE PREFERRED EMBODIMENTS

### First Embodiment

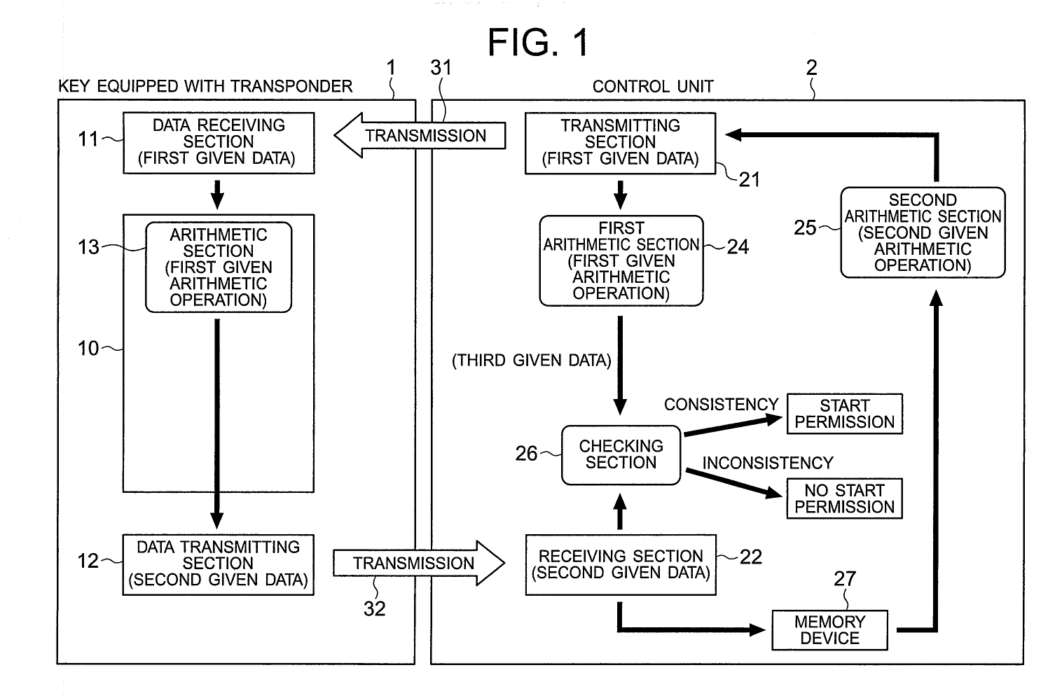

Hereinafter, a description will be given of an antitheft coding device according to a first embodiment of the present invention with reference to FIG. 1. Referring to FIG. 1, reference numeral 1 denotes a key that is carried by a user and constituted of a mechanical key having a transponder 10 therein. Reference numeral 2 is a control unit that is disposed on a vehicle side. The key 1 includes a data receiving section 11 having an amplifier (hereinafter referred to as AMP) (not shown) for receiving power feeding data and first given data which are transmitted from the control unit, and an arithmetic section 13 that conducts given arithmetic operation (first given arithmetic operation) on the first given data that has been received by the data receiving section 11 to generate second given data. The key 1 also includes a data transmission section 12 having an AMP for transmitting the second given data that has been generated by the arithmetic section 13 to the control unit 2.

The control unit 2 includes a transmitting section 21 that transmits the first given data and the power feeding data to the key 1, a receiving section 22 that receives the second given data that has been transmitted from the key 1. The control unit 2 also includes a first arithmetic section 24 that conducts the same given arithmetic operation as the given arithmetic operation (first given arithmetic operation) that is conducted by the arithmetic section 13 of the key 1 on the same data as the first given data that has been transmitted to the key 1 to generate third given data having the same number of bytes as that of the second given data. The control unit 2 further includes a checking section 26 that checks the second data that has been transmitted from the key 1 against the third data that has been generated by the first arithmetic section 24. Namely, the checking section 26 verifies the second data with the third data so as to confirm whether those data coincide with each other or not. The control unit 2 also includes a memory device 27 that stores the second given data that has been received by the receiving section 22 from the key 1, and a second arithmetic section 25 that conducts given arithmetic operation (second given arithmetic operation) on the second given data that has been stored in the memory device 27 to generate a new first given data used for subsequent checking. It is assumed that the first given arithmetic operation and the second given arithmetic operation are different from each other. Also, in this embodiment, the initial first given data uses an initial value that is prepared in advance and generated by using random numbers in a manufacturing process.

Subsequently, the operation will be described. First, in order to start the transponder 10 that is equipped in the key 1, the power feeding data is output from the transmitting section 21 of the control unit 2 to the key 1 (transmission 31). Upon receiving the power feeding data, the data receiving section 11 of the key 1 conducts a converting process on the power feeding data by the AMP, and outputs the converted data to the transponder 10. After the transponder 10 starts up due to the power feeding data, the control unit 2 transmits the first given data to the transponder 10 through the AMP of the data receiving section 11 of the key 1 (transmission 31). The transponder 10 conducts the given arithmetic operation (first given arithmetic operation) on the transmitted first given data by the arithmetic section 13, and generates the second given data having the number of bytes different from the number of bytes of the first given data. The generated second given data is transmitted to the control unit 2 through the AMP of the data transmitting section 12 (transmission 32).

The control unit 2 receives the second given data, conducts the same arithmetic operation as the given arithmetic operation (first given arithmetic operation) that is conducted on the first given data on the key 1 side, on the same data as the first given data that has been transmitted to the transponder 10, and generates the third given data having the number of bytes which are different from that of the first given data and identical with that of the second given data. Then, the checking section 26 checks the second given data that has been transmitted from the key 1 with the generated third given data. The checking section 26 permits the start of an engine when those data coincide with each other, but does not permits the start of the engine when those data do not coincide with each other so as to conduct the antitheft.

In this situation, regardless of consistency or inconsistency of the checking results, the second given data that has been received by the receiving section 22 is required to generate the first given data which is used for the subsequent checking. For that reason, the second given data is stored in the memory device 27. At the time of subsequent checking, the given arithmetic operation (second given arithmetic operation) is conducted on the basis of the stored second given data to generate the first given data having the number of bytes that is different from that of the second given data. For example, four arithmetic operations are performed on the second given data as the given arithmetic operation (second given arithmetic operation) to generate the first given data having the different number of bytes. The first given data thus generated is transmitted to the transponder 10 on the key 1 side. As a result, the memory capacity for generating the first given data which is used for checking can be minimized, and the given arithmetic operation is conducted on the second given data that has been stored in the memory device 27, thereby making it possible to easily generate the first given data different each time.

As described above, in this embodiment, the first given data is transmitted from the control unit 2 on the vehicle side, the key 1 that is equipped with the transponder 10 conducts the given arithmetic operation (first given arithmetic operation) on the basis of the transmitted first given data to generate the second given data, and transmits the data to the control unit 2. The control unit 2 checks whether the result obtained by the internal arithmetic operation coincides with the second given data or not, and permits the start of the engine. Also, the control unit 2 stores the second given data therein in advance, conducts the given arithmetic operation (second given arithmetic operation), and uses the stored second given data as the subsequent first given data. With the above configuration, the memory can be minimized. In addition, the first given data and the second given data are made different from each other in the number of bytes, thereby making it possible to enhance the security. As described above, according to this embodiment, the high security can be ensured with the use of a memory having a small capacity. Also, since the capacity of the memory is small, the device can be downsized, and the costs can be suppressed.

### Second Embodiment

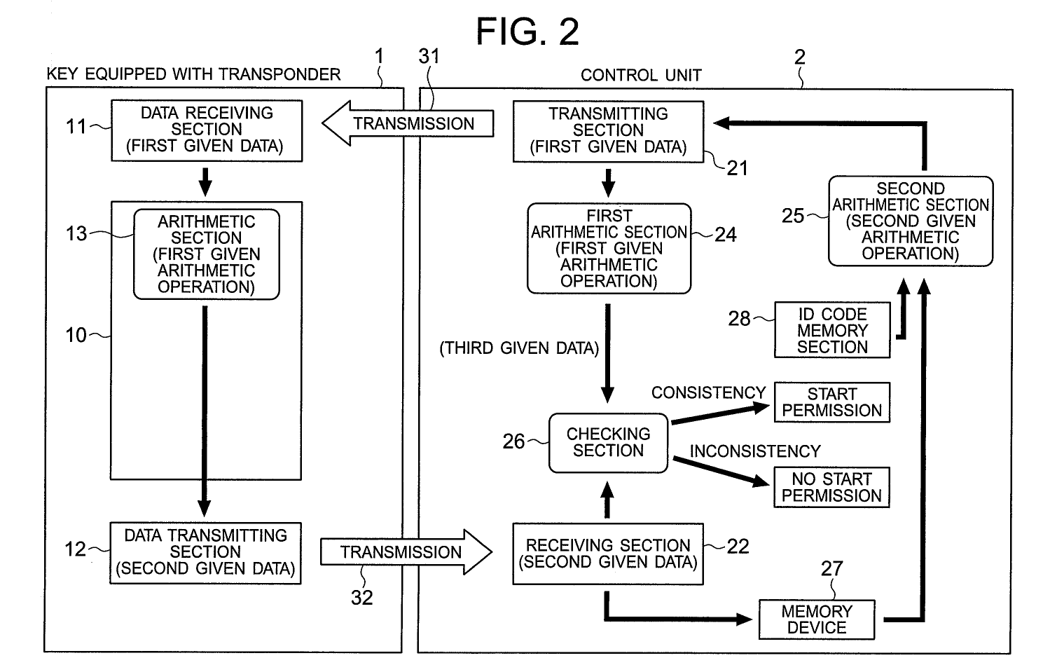

Hereinafter, a description will be given of an antitheft coding device according to a second embodiment of the present invention with reference to FIG. 2. Referring to FIG. 2, reference numeral 28 denotes an ID code memory section that stores an ID code specific to a vehicle therein. Other configurations are identical with those shown in FIG. 1, and therefore the same parts are denoted by identical references and their description will be omitted.

At an initial time at which the antitheft coding device of the present invention is fitted to the vehicle, the second given data is not stored in the memory device 27, so the first given data cannot be produced. When a fixed value is used in order to eliminate the above problem, data is identical with that of other vehicles, and the security is reduced. Under the circumstances, in the first embodiment, the first given data at the initial time uses the initial value that is generated by using random numbers and prepared in advance. On the other hand, in the second embodiment, only at the initial time, an ID code specific to the vehicle is read from the ID code memory section 28, and the given arithmetic operation (second given arithmetic operation) is implemented by the second arithmetic section 25 with the use of the ID code as the second given data to generate the first given data. As a result, it is possible to prevent the same first given data as that of other vehicles from being used. Other operation is identical with that in the first embodiment, and therefore will be omitted.

As has been described above, according to the second embodiment, the same advantages as those in the above first embodiment can be obtained. Also, the ID code specific to the vehicle is used as the second data at the initial time, and the given arithmetic operation (second given arithmetic operation) is conducted on the ID code to generate the first given data used for the initial checking. As a result, it is possible to prevent the first given data from being identical with that of other vehicles. Also, because the existing ID code is used, an initial process of generating the data is not required, thereby making it possible to ease the manufacturing process.

What is claimed is:

1. An antitheft coding device, comprising:
a key on a user side; and
a control unit equipped on a vehicle side,
wherein the key includes:
a data receiving section that receives first given data that is transmitted from the control unit;
an arithmetic section that conducts a first given arithmetic operation on the received first given data to generate second given data; and
a data transmitting section that transmits the generated second given data to the control unit,
wherein the control unit includes:
a transmitting section that transmits the first given data to the key;
a first arithmetic section that conducts the same arithmetic operation as the first given arithmetic operation on the same data as the transmitted first given data to generate third given data;
a receiving section that receives the second given data from the key;
a checking section that checks the third given data generated by the first arithmetic section against the second given data that has been received by the receiving section, and permits a start of an engine equipped in a vehicle when the third given data and the second given data coincide with each other;
a memory section that stores the second given data that has been received by the receiving section; and
a second arithmetic section that conducts a second given arithmetic operation on the second given data that has been stored in the memory section to generate first given data to be transmitted to the key for subsequent checking, and
wherein the second given data has the same number of bytes as the number of bytes of the third given data, which is different from the number of bytes of the first given data.

2. An antitheft coding device according to claim 1, wherein the first given data used at a time of first checking is generated by the second given arithmetic operation by using an ID code specific to a vehicle.
